(19) United States
(12) Patent Application Publication
(10) Pub. No.: US 2016/0296949 A1
(43) Pub. Date: Oct. 13, 2016

(54) A DEVICE AND A HYDRODYNAMIC NOZZLE FOR A GENERATION OF A HIGH PRESSURE PULSATING JET OF A LIQUID WITHOUT CAVITATION AND SATURATED VAPOUR

(71) Applicant: INSTITUTE OF GEONICS AS CR, V. V. I., Ostrava (CZ)

(72) Inventor: Zdenek RIHA, BRNO (CZ)

(21) Appl. No.: 15/034,581

(22) PCT Filed: Nov. 11, 2014
(86) PCT No.: PCT/IB2014/065941

§ 371 Date: May 5, 2016

(30) Foreign Application Priority Data
Nov. 11, 2013 (CZ) 2013-871

(51) Int. Cl. B05B 1/08; B08B 3/02

(52) U.S. Cl. CPC B05B 1/08; B08B 3/022

(57) ABSTRACT

A device and a hydrodynamic nozzle for a generation of a high pressure pulsating jet of a liquid without cavitation and saturated vapour The device for the adjustment of surfaces and dividing of materials with the hydrodynamic nozzle for the generation of high pressure pulsating jet of liquid without cavitation and presence of saturated vapours. The device for adjustment of surfaces and dividing of materials with the hydrodynamic nozzle generates pulsating jet, which is able to perform a very effective cleaning or removing surfaces of materials or dividing the given bodies of materials. The device could be composed of the bearing body (2) and the body of nozzle (1), which are mutually sealed by the sealing (3). The hydrodynamic nozzle, which consists of input openings (22) of oscillatory chamber (20), the oscillatory chamber (20) and the output neck (21), allows constructing a very small, effective and reliable device for the cleaning of surfaces, removing of surfaces and for dividing of materials by pressure liquid. A high efficiency and reliability is also achieved, because in the whole device, in the input opening of device (25), in the input channel (24), in the relief opening and in others parts it does not come to the formation of cavitation or to the formation of saturated vapours, even at a very high operating power supply pressures.

A device and a hydrodynamic nozzle for a generation of a high pressure pulsating jet of a liquid without cavitation and saturated vapour.

### FIELD OF TECHNOLOGY

Technical solution of device falls within the field of hydraulics. The aim of patent is the device for the cleaning/removing of surfaces of materials and dividing of materials by the jet of liquid with the usage of hydrodynamic nozzle in which it leads to the self-excited oscillation of pressure and flow without the presence of cavitation or saturated vapour in the nozzle.

### STATE OF THE ART

Currently, pulsation of pressure and flow is used for the purpose of decay (modulation) of liquid jet on the output from the device for the cleaning/adjustment of surfaces and dividing of materials. The jet divided into the individual clusters of liquid considerably increases the straining of material surface on which the jet falls. There comes to a very intensive fatigue straining caused by the influence of big and rapid change of impact pressure of liquid. The mentioned effect has a consequence in the damage of material surface or its dividing under the significantly favourable energetic conditions compared to the state when from the device rises the continuous jet of liquid, where does not come to the significant change of impact pressure in time. In other words, it is sufficient to have the significantly lower value of power supply pressure at pulsating jet for damaging or dividing of material in comparison with continuous jet. The lower value of power supply pressure leads also to the significantly lower structural demands for the construction, respectively for the manufacture of pressure device. In general, it is known a several methods for the induction of flow and pressure pulsation of liquid in the stated device, which subsequently lead to decay of the jet at the output from the device.

The given methods could be divided into two categories:
1. Pulsations of flow and pressure in the device are induced by the addition of other energy to the given energy contained in flowing liquid.
2. Pulsations of flow and pressure are induced only by the given energy contained in flowing liquid.

Into the first category belong the inner mechanical modulators of flow; see the patent US2013/0057045A1. The output jet contains rotating disc with openings, which by its movements closes and opens the hydraulic circuit. Thereby it comes to the division of jet at the output from the stated device. The disadvantage of this manner of manufacture of divided liquid jet is that in the given device is created the extreme dynamic strength straining on used components, which has the negative impact on service life of whole device. The presence of rotating component in the device decreases its reliability and significantly reduces flexibility of its usage. During the operation it is wasted more than half of given hydraulic energy, which is then not further constructively used. This is also negatively reflected by noise and by vibrations of device. The total energetic benefit could be very small or none in comparison with continual jet at all.

Into the first category also belongs so called acoustic generation by pulsation of pressure and flow. The part of device is the electromechanical acoustic driver, which induces by the passing of alternating current the deformation of its parts situated into the device; see patents U.S. Pat. Nos. 5,020,724, 7,594,514 B2, CZ 299412 B6. Deformations of acoustic driver are transmitted into the liquid, where it comes to the formation of pressure and flow pulsations. These have then in a consequence the decay of jet at the output from the device. By this manner it could be achieved a very effective modulation (division) of output jet of liquid. The disadvantage of above mentioned device consists in, that the presence of acoustic driver decreases reliability of device and reduces flexibility of its usage. Another disadvantage is also that the stated acoustic driver operates only on the one frequency. If it comes to the change of power pressure and flow of liquid in the device, so that it will also change the output shape of liquid jet.

Into the second category belong devices which contain nozzles based on so-called Helmholtz resonator; see patents EP0607135B1 and U.S. Pat. No. 4,041,984. There is used the fact that with the periodic change of flow section it could be connected the formation of self-excited pulsations of pressure and flow of liquid. However, this method is poorly applicable in the area of high pressures (20 MPa and more) because of big dissipation of energy and for the presence of cavitation or saturated vapours. The efficiency of liquid decay on the output from the nozzle of device significantly decreases, if we need to utilize the smaller size of output opening of nozzle.

Into the second category also belong devices which use fluidic nozzles, where it comes to the spontaneous formation of pulsations under the influence of shape of flow area; see patents W02012/145534A1 US006029746A US006253782B1. The difficulty at these devices is the fact that higher operating pressures (20 MPa and more) cause the formation of cavitation and the presence of saturated vapours in the significant volume of nozzle. As the result of that then it comes to the significant damping of pressure and flow pulsations, or amplitudes of pressure and flow oscillation are very low at given frequencies. The liquid jet is then not divided on the output from the device or nozzles by the necessary manner and its effect is almost identical with continual jet. The other disadvantage also consist in that the own oscillatory chamber is complicated in a shape, therefore it is demanding in a construction.

### DESCRIPTION OF THE INVENTION

The subject of invention is the hydrodynamic nozzle and device, which the nozzle is a part of, for generation of self-excited pulsations of pressure and flow, which lead to the effective decay of liquid jet even at a high power supply pressure (5 MPa and more). Pulse jet is able to perform a very effective cleaning, respectively removing of surfaces of materials or dividing the given bodies of materials.

The sufficiently big amplitudes of pressure and flow oscillation are although possible to gain on frequencies considerable higher than 1 kHz. The nature of this manner consist in that the hydrodynamic nozzle is constructed in a way so that it could not come to the formation of cavitation or saturated vapour especially in the area of input and oscillatory chamber. Thereby, the undesirable damping by pulsation of hydraulic quantities is eliminated. The nozzle therefore generates the significant pulsations of pressure and flow on a very high frequencies, which influence the decay of liquid jet on the output from the device, in order of units up to hundreds thousands Hertz according to the value of power supply pressure, respectively according to the flow of liquid and a type of nozzle construction. Hereby designed hydrodynamic nozzle allows the effective decay of liquid jet on the output, however already without a need of additional energy for generation of pulsations. The hydrodynamic nozzle for generation of pulsations without the concomitant cavitation and formation of saturated vapours contains three basic parts; input openings of oscillatory chamber, which are two at least; the oscillatory chamber and the output neck, with the advantage of that these shapes are milled into the material.

The cross-sectional area of input openings of oscillatory chamber has to be larger or maximally equal as the cross-sectional area of output neck of oscillatory chamber. More precisely, the total flow cross-sectional area of input openings of oscillatory chamber is larger than the flow cross-sectional area of output neck.

After the removing of cavitation formation and presence of saturated vapours it is favourable to choose a size (the cross-sectional area) of input oscillatory openings larger than a size of output neck. Thereby the sufficient high value of pressure in the oscillatory chamber is gained.

It is favourable to choose the input openings into the oscillatory chamber with constant, for example with rectangular/cylindrical diameter or with linearly narrowing diameter in the flow direction, so-called confuser. The shape of confuser is advantageous with regard to prevention against to the formation of cavitation and reduction of hydraulic losses. The diffuser shape (the shape is broadening out in the flow direction) of input openings is unfavourable because of sensitivity to the formation of cavitation and presence of saturated vapours and slowdown of flow in the oscillatory chamber. For the achievement of high values of frequencies and amplitudes of pressure and rate oscillation of liquid in the hydrodynamic nozzle it is suitable to place the input openings of oscillatory chamber next to each other, opposite to the output neck. The selected configuration of placement and shape of input openings of oscillatory chamber and output neck allow using a very simple shape of oscillatory chamber. The shape of oscillatory chamber is then possible to select the simplest in a form of rectangle, square or circle. Thereby is significantly simplified the manufacture of nozzle's body. The location, shape and size of input openings of oscillatory chamber and output neck define a range of pulsations of pressure and flow of liquid. The shape of output neck is not limited; it could be for example constant diameter or the shape of confuser or diffuser or their any combination. It is favourable to select the shape of constant diameter, for example cylinder/rectangle/hexagon or a combination of the shape of constant diameter and diffuser, for example trapezoid/truncated cone/truncated pyramid. Thereby is allowed the decay of jet with larger angle of spray, if it is required. The output neck is possible to select as the confuser, therefore the shape is narrowing in the flow direction, for example trapezoid/truncated cone/truncated pyramid. In this manner the formation of cavitation and saturated vapours also in the output neck of hydrodynamic nozzle is eliminated. The whole device is composed of bearing body and nozzle's body. The device could be supplemented by sealing between the bearing body and nozzle's body. The purpose of bearing body consists in possibility of liquid intake at a high pressure into the nozzle's body. The bearing body contains the input opening of device, which is connected with the input channel and that continues in the input openings of oscillatory chamber, which are already part of nozzle. In the body of nozzle is created the geometry of hydrodynamic nozzle. The nozzle is composed of input openings of oscillatory chamber, the oscillatory chamber and the output neck. After the output neck it could follow the relief opening situated in the bearing body or in the union nut, which allows the flow of pulsating liquid out of the device. The nozzle's body could be manufactured from one piece or it could be divided in several individual parts according to the selected technology of manufacture. It is favourable to divide the nozzle's body into two parts, where the first part contains the input openings of oscillatory chamber with the oscillatory chamber and the second part contains the output neck. Thereby the significant simplification of device manufacture is achieved.

The advantage of described solution lies in the saving of energy, because of it is not necessary to have the additional energy for induction of flow and rate pulsations. The device containing the hydrodynamic nozzle is then a very small, lightweight and flexible for usage in practice. The device is also able to operate in a very broad spectrum of power supply pressures because of that the frequency of pulsations (of pressure and flow) increases with the increasing value of power supply pressure or flow. The construction of device is developed so that the cavitation and saturated vapours will not be able to participate in damping of pressure flow pulsations. The other significant advantage consists in that the hydrodynamic nozzle allows to generate the pressure and flow pulsations of sufficient amplitude and frequency, because of that it comes to the decay of liquid jet on the output from the device, where its effects express themselves very effective at cleaning/removing of surfaces, or at splitting of materials.

Structural materials of device are selected according to what kind of pressures and frequencies are necessary to induce for specific operations. It depends on strength and durability of purified material and surface impurity or material, which has to be divided or adjusted in a different way, such as the creation of hollows, grooves, purifying of surfaces, division of material etc. For example, it is necessary to have a low power supply pressure for a gentle cleaning of teeth; therefore it is sufficient to select the body of nozzle and the bearing body from plastic materials. Whereas, for example with the cutting of metal materials it would be necessary to have high power supply pressures, therefore the body of nozzle and the bearing body are selected from a strong metal materials, because the demands for the resistance of structural materials are much higher.

### SUMMARY OF FIGURES ON DRAWINGS

FIG. 1 The device with the hydrodynamic nozzle manufactured in the front of cylindrical body, 1A is a spatial view, and 1B is a sectional view. The body of nozzle 1 is placed in the bearing body 2 together with the sealing 3. In the bearing body 2 as well as in the sealing 3 is manufactured the input opening of the device 25. The input opening of device 25 is connected to the input channel 24, which leads to the input openings 22 of oscillatory chamber 20. The geometry of input openings 22 has the rectangular cross-section and is narrowing in the flow direction. The oscillatory chamber 20 is ended with the output neck 21 in the shape of truncated cone, which is narrowing in the flow direction, on which continues the relief opening 40 anchored in the bearing part 2.

FIG. 2 The device with the hydrodynamic nozzle manufactured in the cylindrical body. 2A is a spatial view, 2B is a sectional view. The body of nozzle 1 is placed in the bearing body 2 together with the sealing 3. In the bearing body 2 is manufactured the input opening of the device 25. The input opening of device 25 is connected to the input channel 24, which leads to the input openings 22 of oscillatory chamber 20. The geometry of flow cross-section of input openings 22 has the rectangular shape and it is not changed in the flow direction. The oscillatory chamber 20 is ended with the output neck 21 in the shape of the cuboid and subsequently is broadening out into the lowered truncated cone.

FIG. 3 The device with the hydrodynamic nozzle manufactured from two cylindrical bodies. 3A is a spatial view, 3B is a sectional view. The device is composed of four bodies. The body of nozzle 1 contains only the input openings 22 of oscillatory chamber 20 and the oscillatory chamber 20. The additional part 8 of nozzle's body 1 contains the output neck 21. The body of nozzle 1 and the additional part 8 are placed in the bearing body 2. The location of nozzle's body 1 and the additional part 8 is fixed in the bearing body 2 by using of union nut 4, whose part is the relief opening 40. The bearing body 2 and the union nut 4 are mutually tightly connected.

FIG. 4 Figure shows the device with the hydrodynamic nozzle and the circular oscillatory chamber. 4A is a spatial view, 4B is a sectional view. The device is formed from three bodies, the body of nozzle and two stoppers. The body of nozzle 1 is at the same time also the bearing body of the device. The oscillatory chamber 20 has the circular shape. The body of nozzle 1 contains the input opening of device 25 the input channel, 24 the input openings 22 of oscillatory chamber, the oscillatory chamber 20 the output neck 21 and the relief opening. 40. The space of oscillatory chamber is defined by two opposite stoppers 5. From the oscillatory chamber 20 the pressure pulsating liquid gets off by the output neck 21 in the shape of cylinder. From the device the pressure liquid then flows through the relief opening 40 in the body of nozzle 1.

FIG. 5 Figure shows the nozzle for generation of high pressure pulsating jet of liquid without the cavitation and saturated vapours. 5A is a spatial view, 5B is a sectional view. The body of nozzle 1 contains the input openings 22 of oscillatory chamber 20, the oscillatory chamber 20 and the output neck 21.

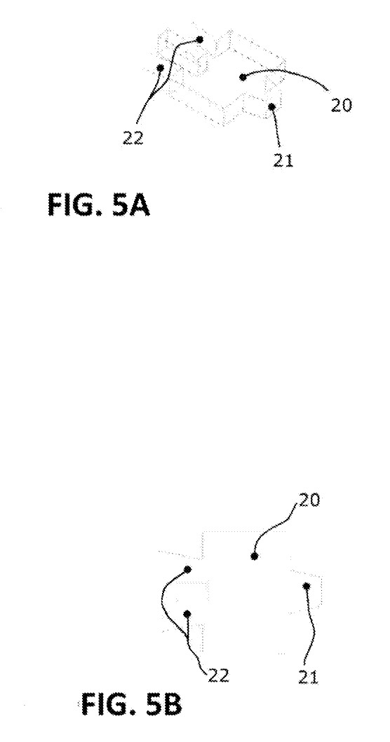

### EXAMPLES OF THE INVENTION

### Example 1

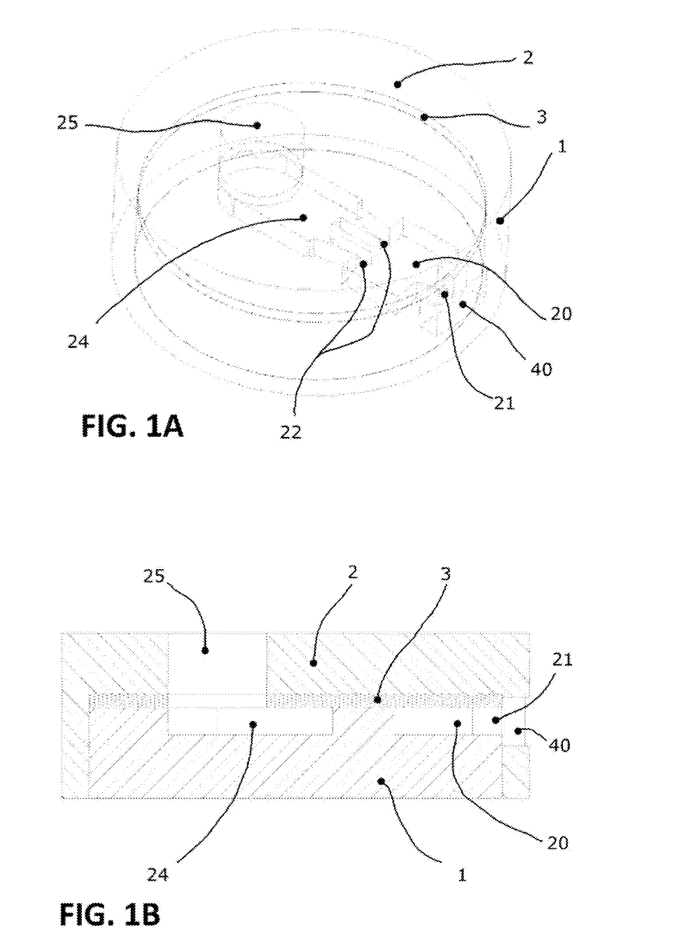

FIGS. 1A and 1B show the example of design of device with the hydrodynamic nozzle. The device is formed by three bodies. The body of nozzle 1 is placed in the bearing body 2 together with the sealing 3. The sealing 3 is used to prevent from leaking of pressure liquid between front surfaces of nozzle's body 1 and the bearing body 2. The body of nozzle 1, the bearing body 2 and the sealing 3 are mutually connected with tight, screw connection as the advantage. The shape of hydrodynamic nozzle is manufactured in the body of nozzle 1. The pressure liquid enters into the device through the input opening of device 25 manufactured both in the bearing body 2 as well as also in the sealing 3. Brought pressure liquid further continues by the input channel 24 into the input openings of oscillatory chamber 22. The geometry of input openings of oscillatory chamber 22 has the rectangular cross-section and is narrowing in the flow direction. After the openings follows the oscillatory chamber 20. In the oscillatory chamber 20 it comes to the formation of flow instability, which is expressed by the flow and rate pulsations. From the oscillator chamber 20 gets out the pressure pulsating liquid through the output neck 21 in the shape of truncated cone, which is narrowing in the flow direction. From the device then the pressure liquid flows through the relief opening 40 in the bearing part 2.

The material of nozzle's body 1, bearing body 2 and sealing 3 is selected according to the amount of power supply. The body of nozzle 1 and the bearing body 2 are manufactured from the steel 17022. The sealing is manufactured from zinc sheet metal.

The above stated structural solution allows the simply manufacture of the shape of hydrodynamic nozzle. The device was used for the adjustment of surface of aluminium part at the power supply pressure of 20 MPa and with the gained frequency 30 kHz.

### Example 2

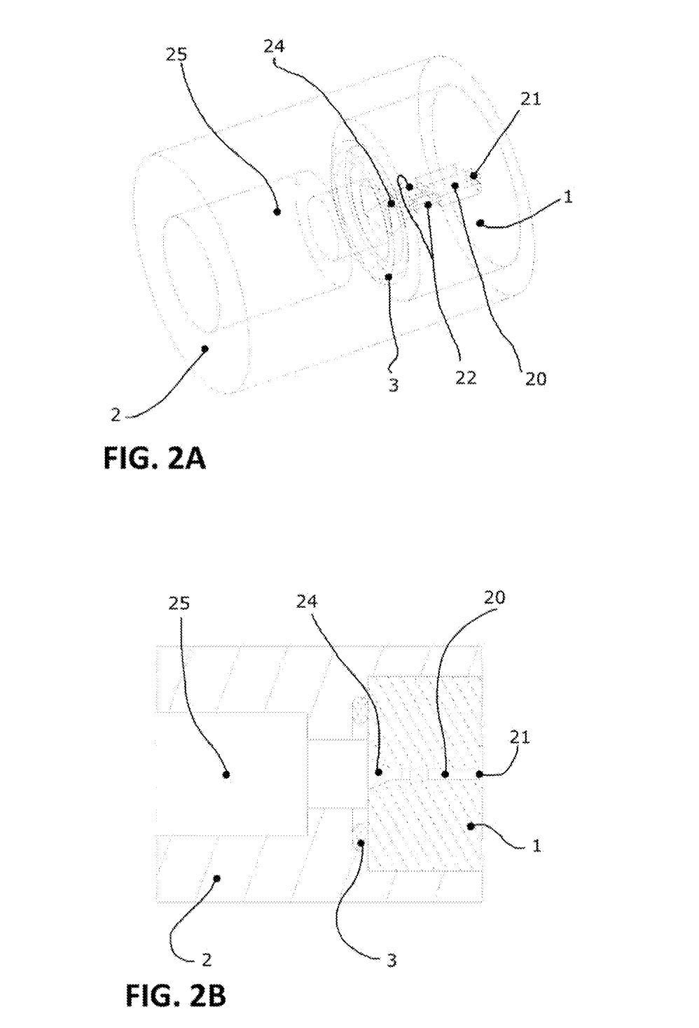

FIGS. 2A and 2B show the example of design of device with the hydrodynamic nozzle. The device is formed by three bodies. The body of nozzle 1 is placed in the bearing body 2 together with the sealing 3. The sealing 3 is used to prevent from leaking of pressure liquid between front surfaces of nozzle's body 1 and the bearing body 2. The body of nozzle 1, and the bearing body 2 and the sealing 3 are mutually tightly connected with the screw connection as the advantage. The shape of hydrodynamic nozzle is manufactured in the body of nozzle 1. The pressure liquid enters into the device through the input opening of device 25 manufactured in the bearing body 2. Brought pressure liquid further continues by the input channel 24 into the input openings 22 of oscillatory chamber. The geometry of flow cross-section of the input openings 22 of oscillatory chamber has the rectangular shape and is not changed in the flow direction. After the openings follows the oscillatory chamber 20. The oscillatory chamber has the rectangular shape. In the oscillatory chamber 20 it comes to the formation of flow instability, which is expressed by the flow and rate pulsations. From the oscillatory chamber 20 gets out the pressure pulsating liquid through the output neck 21 in the shape of cuboid and lowered truncated cone, which is broadening out. The material of nozzle's body 1, bearing body 2 and sealing 3 is selected according to the amount of power supply. The body of nozzle 1 is manufactured from the alloy of aluminium AS7G06 and the bearing body 2 is manufactured from the stainless 17022. The sealing is manufactured from rubber NBR70.

The above stated structural solution allows the maximum approximation of nozzle's body 1 to the given surface of purified or divided body and the structural solution also allows reaching very small dimensions of particular device with the hydrodynamic nozzle. The device was used for the formation of groove about the depth of 2 mm in the aluminium body at 40 MPa of power supply pressure, with the gained frequency of 50 kHz.

### Example 3

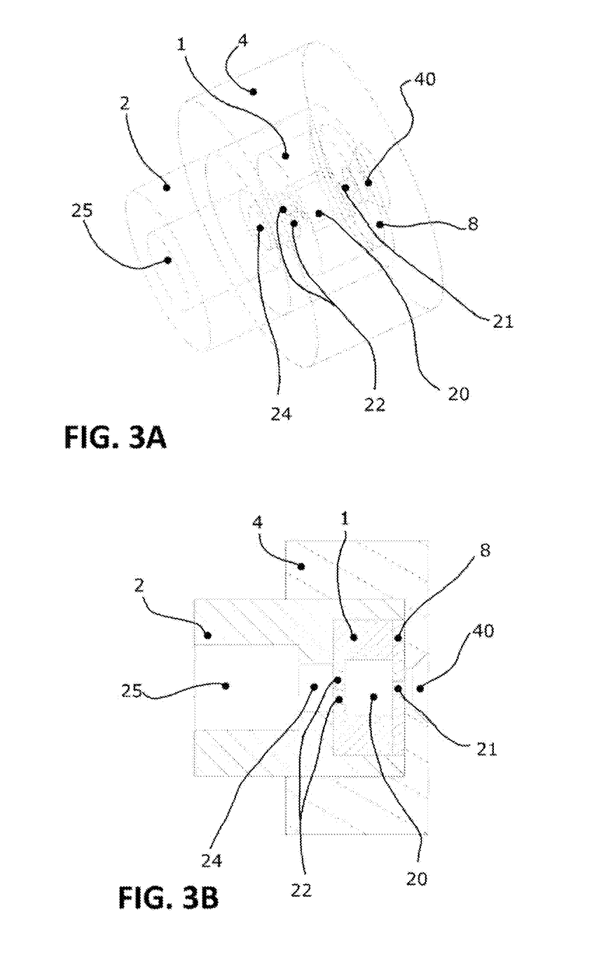

FIGS. 3A and 3B show the example of design of device with the hydrodynamic nozzle. The device is formed by four bodies. The body of nozzle 1 contains only the input openings 22 of oscillatory chamber 23 and the oscillatory chamber 20. The additional part of nozzle's body 8 contains the output neck 21. The hydrodynamic nozzle is therefore divided into two parts. The body of nozzle 1 and the additional part of body of nozzle 8 are placed in the bearing body 2. The location of additional part 8 of body of nozzle 1 is fixed in the bearing body 2 by using of the union nut 4. The bearing body 2 and the union nut 4 are mutually connected by the screw connection. The pressure liquid enters into the device through the input opening of device 25 manufactured in the bearing body 2. Brought pressure liquid further continues by the input channel 24 into the input openings of oscillatory chamber 23 and 22. The geometry of input openings of oscillatory chamber 23 and 22 is formed by truncated cones, which are narrowing in the flow direction. After that follows the oscillatory chamber 20. In the oscillatory chamber 20 it comes to the formation of flow instability, which is expressed by the flow and rate pulsations. From the oscillatory chamber 20 gets out the pressure pulsating liquid through the output neck 21 in the shape of cylinder. Further, from the device the pressure liquid flows through the relief opening 40 in the union nut 4.

The material of nozzle's body 1 bearing body 2 and sealing 3 is selected according to the amount of power supply. The body of nozzle 1 and the additional part of body of nozzle 8 are manufactured from plastic VisiJet EX200. The bearing body 2 is manufactured from the alloy of aluminium CERTAL. The union nut 4 is manufactured from bronze CuSn8P-F54.

The above stated structural solution allows the simply manufacture of the shape of hydrodynamic nozzle and the structural solution also allows reaching very small dimensions of particular device with the hydrodynamic nozzle. The device was proposed for the tissue division, with maximum pressure of 15 MPa.

### Example 4

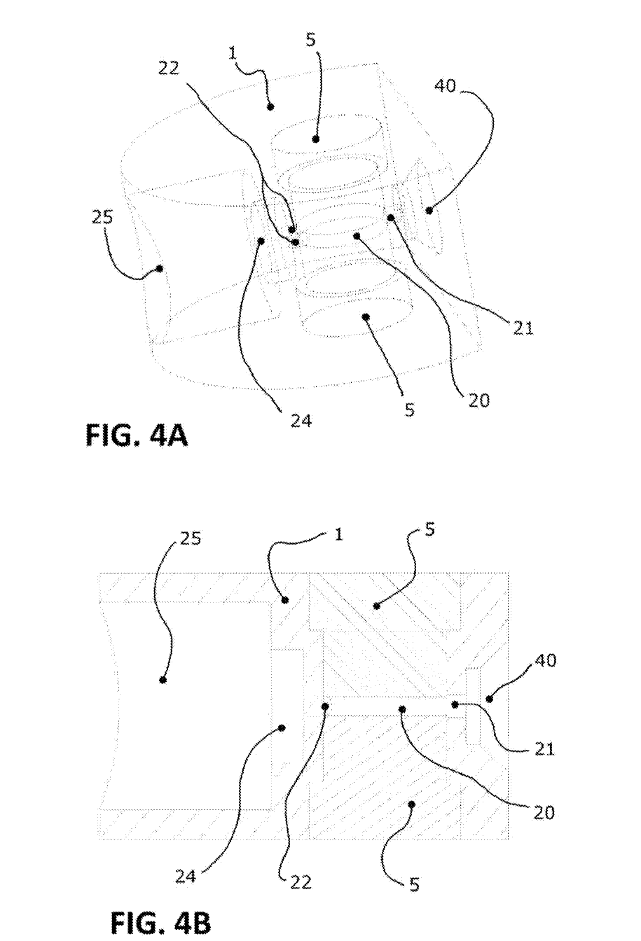

FIGS. 4A and 4B show the example of design of device with the hydrodynamic nozzle. The device is formed by three bodies, the body of nozzle and two stoppers. The body of nozzle 1 is at the same time also the bearing body of device. The oscillatory chamber 20 has the circular shape. The body of nozzle 1 contains the input opening of device 25 the input channel 24 and the input openings 22 of oscillatory chamber, the oscillatory chamber 20, the output neck 21 and the relief opening 40. The space of oscillatory chamber is defined by the two opposite stoppers 5. Stoppers 5 should be towards to the body of nozzle 1 sealed, in case of need. The stopper 5 and the body of nozzle 1 are connected through the screw connection. The pressure liquid enters into the device through the input opening of device 25. Brought pressure liquid further continues by the input channel.

### INDUSTRIAL APPLICABILITY

A cleaning/removing of surfaces of materials and dividing of materials by the jet of liquid with the usage of hydrodynamic nozzle in which it leads to the self-excited oscillation of pressure and flow without the presence of cavitation or saturated vapour in the nozzle.

1. A hydrodynamic nozzle for a generation of a high pressure pulsating jet of a liquid without cavitation and presence of saturated vapours, which is characterized by the fact, that it is composed of an oscillatory chamber (20), at least two input openings (22) of the oscillatory chamber (20) and a output neck (21) of the oscillatory chamber (20), where a flow cross-sectional area of the input openings (22) of the oscillatory chamber (20) is larger or equal than the flow cross-sectional area of the output neck (21) of the oscillatory chamber (20), where input openings (22) of the oscillatory chamber (20) have constant or diminishing cross-section in a flow direction, wherein sectionally the oscillatory chamber (20) has the biggest dimension maximum four times bigger than input openings (22) dimension.

2. The hydrodynamic nozzle for the generation of the high pressure pulsating jet of the liquid without cavitation and presence of saturated vapours according to claim 1, wherein the input openings (22) of the oscillatory chamber (20) are placed next to each other, opposite to the output neck (21) of the oscillatory chamber (20) that sectionally the output neck (21) is centred in relation to the input openings (22) and reciprocal distance of the input openings (21) is maximum two times bigger than dimension of one from the input openings (21).

3. The hydrodynamic nozzle for the generation of the high pressure pulsating jet of the liquid without cavitation and presence of saturated vapours according to claim 1, wherein sectionally the input openings (22) dimension of the oscillatory chamber (20) is 17 to 50% bigger than output neck (21) dimension.

4. The hydrodynamic nozzle for the generation of high pressure pulsating jet of the liquid without cavitation and presence of saturated vapours according to claim 1, wherein the input openings (22) of the oscillatory chamber (20) have a shape of a rectangle or a cylinder or a truncated pyramid or a truncated cone or their combination.

5. The hydrodynamic nozzle for the generation of high pressure pulsating jet of the liquid without cavitation and presence of saturated vapours according to claim 1, wherein the output neck (21) of the oscillatory chamber (20) has the dwindling cross-section in the flow direction.

6. The hydrodynamic nozzle for the generation of high pressure pulsating jet of the liquid without cavitation and presence of saturated vapours according to claim 1, wherein the oscillatory chamber (20) has the square or rectangular shape or circular cross-section.

7. (currently am ended): A device with the hydrodynamic nozzle for the generation of high pressure pulsating jet of the liquid without cavitation and presence of saturated vapours according to claim 1, wherein it is composed of the hydrodynamic nozzle (1) and a bearing body (2), where the hydrodynamic nozzle (1) is tightly anchored in the bearing body (2) and the bearing body (2) contains the input channel (24), which is connected with the input openings (22) of the oscillatory chamber (20) and linked to the input opening (25) of device.

8. The device with the hydrodynamic nozzle according to claim 7, wherein on the output neck (21) a relief opening (40) is connected.

9. The device with the hydrodynamic nozzle according to claim 8, wherein it contains the relief opening (40), which is a part of union nut (4), which is tightly connected to the bearing body (2).

10. The device with the hydrodynamic nozzle according to claim 7, wherein the bearing body (2) and the body of nozzle (1) are mutually sealed by a sealing (3).

11. An use of the hydrodynamic nozzle for the generation of high pressure pulsating jet of the liquid without cavitation and presence of saturated vapours according to claim 1 for the cleaning or removing of surfaces or for the adjustment of surfaces of materials or for dividing of materials.

12. An use of the device with the hydrodynamic nozzle according to claim 7 for the cleaning or removing of surfaces or for the adjustment of surface of materials or for dividing of materials.
